(19) United States
(12) Patent Application Publication
(10) Pub. No.: US 2002/0152161 A1
(43) Pub. Date: Oct. 17, 2002

(54) Credit transfer method for a computer network capable of transferring amounts of money to a plurality of bank accounts in order of respective priorities

(75) Inventor: Tsutomu Aoike, Sendai (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/093,478

(22) Filed: Mar. 11, 2002

(30) Foreign Application Priority Data
Apr. 11, 2001 (JP) 2001-113160

(51) Int. Cl. G06F 17/60

(52) U.S. Cl. 705/39; 705/42

(57) ABSTRACT

A credit transfer method and a credit transfer system for a computer network capable of transferring an incoming amount of money to a plurality of bank accounts based on designated amounts and priorities corresponding to the respective bank accounts. The incoming amount of money is allocated to the bank accounts in order of the designated priorities. If the sum of designated amounts that have already been allocated to corresponding bank accounts is less than the incoming amount of money, but the sum of designated amounts is more than the incoming amount if a designated amount corresponding to the bank account having the next priority is allocated, only the difference between the incoming amount of money and the sum of designated amounts is allocated to the bank account having the next priority. No money is allocated to the bank accounts having lower priorities.

### BACKGROUND OF THE INVENTION

1. Field of the Invention

The present invention generally relates to a credit transfer method for companies to pay salaries and wages to employees' bank accounts, and more particularly, to a credit transfer method that determines amounts paid to a plurality of bank accounts depending on an amount received.

The present invention further relates to a credit transfer system that enables the determination of amounts to be paid to a plurality of bank accounts depending on an amount received and to information storage media in which a computer program that realizes the CREDIT transfer system is stored.

2. Description of the Related Art

Salaries and wages are generally paid by employers directly to bank accounts designated by employees. In the case that the employees need to transfer their money to other accounts, the employees instruct their banks to automatically transfer certain amounts regularly and/or request their employers to pay their salaries and/or wages to a plurality of bank accounts. Occasionally, the employees visit their banks in person.

However, if an employee instructs his/her bank to automatically transfer a certain amount regularly, the bank usually fixes the amount to be transferred. The amount in a destination account cannot be maintained at the same amount. If the employee requests his/her employer to pay his/her salary or wages to a plurality of bank accounts, the treasury department of the employer must arrange a plurality of payments in a short period before the payment. The number of the payments is a multiple of the number of the employees.

If the employee visits his/her bank in person on a payday, he/she has to spend a longer time waiting for his/her turn than usual since the bank is crowded with people visiting for the same purpose.

### SUMMARY OF THE INVENTION

Accordingly, it is a general object of the present invention to provide a novel and useful credit transfer method in which one or more of the problems described above are eliminated.

Another and more specific object of the present invention is to provide a credit transfer method that determines amounts to be paid to a plurality of bank accounts depending on an amount received.

Yet another object of the present invention is to provide a credit transfer system that determines amounts to be paid to a plurality of bank accounts depending on an amount received and information storage media in which a computer program that realizes the credit transfer system is stored.

To achieve one of the objects, a method of transferring a pool of a predetermined amount of money to a plurality of bank accounts through a computer network, according to the present invention, includes the steps of receiving information indicating a priority order of the bank accounts and indicating money amounts that are to be transferred to the respective bank accounts, transferring the money amounts from the pool to the respective bank accounts in the order of the bank accounts as long as sufficient money to transfer remains in the pool, and transferring all money remaining in the pool to a bank account that is next to receive money transfer in the order of the bank accounts if all the remaining money in the pool is not sufficient for the indicated money amount to be transferred to the bank account.

According to the present invention, the predetermined amount of money is transferred to the bank accounts in the money amount in the order indicated in the information provided by the user. If the predetermined amount of money is large enough, all bank accounts are transferred the money amounts that are to be transferred. If the predetermined amount of money is not large enough, that is, all the remaining money in the pool is not sufficient for the bank account that is next to receive money transfer in the order of the bank accounts, the bank account receives only the remaining money in the pool. The bank accounts that have lower priorities receive no money.

A user can transfer the pool of the predetermined amount of money, such as a salary the user earns regularly, to a plurality of bank accounts in the order of bank accounts the user designates through the computer network.

The use of the computer network helps the user save time by not having to visit banks in person and arrange the transfers one by one. Because the user can designate the priorities of the bank accounts, the user can allocate the predetermined amount of money in the order of importance.

Other objects, features, and advantages of the present invention will become more apparent from the following detailed description when read in conjunction with the accompanying drawings.

### BRIEF DESCRIPTION OF THE DRAWINGS

FIG. 1 is a schematic drawing showing a network system in which the credit transfer system is included according to the present invention;

FIG. 2 is a block diagram showing the hardware configuration of the individual credit transfer request system 100, as an embodiment of the present invention;

FIG. 3 is a schematic drawing showing the function of the individual credit transfer request system 100, as an embodiment of the present invention;

FIG. 4 is a schematic drawing showing an example of a credit transfer account selection display 200 as an embodiment of the present invention;

FIG. 5 is a schematic drawing showing an example of a credit transfer request display 210 as an embodiment of the present invention;

FIG. 6 is a schematic drawing showing an example of an account details inquiry display 220 as an embodiment of the present invention;

FIG. 7 is a schematic drawing showing an example of a credit transfer record inquiry display 230 as an embodiment of the present invention;

FIG. 8 is a flow diagram showing the operation of the credit transfer acceptance processing according to the present invention;

FIG. 9A is a schematic drawing showing an example of predicted pay data;

FIG. 9B is a schematic drawing showing an example of actual pay data;

FIG. 9C is a schematic drawing showing an example of credit transfer record data;

FIG. 10 is a schematic drawing showing an example of credit transfer acceptance data;

FIG. 11 is a flow diagram showing the operation of the credit transfer execution processing according to the present invention;

FIG. 12 is a schematic drawing showing an example of credit transfer instruction data;

FIG. 13 is a schematic drawing showing an example of credit transfer journal entry data; and

FIG. 14 is a flow diagram showing the operation of the credit transfer record inquiry processing according to the present invention.

### DETAILED DESCRIPTION OF THE PREFERRED EMBODIMENTS

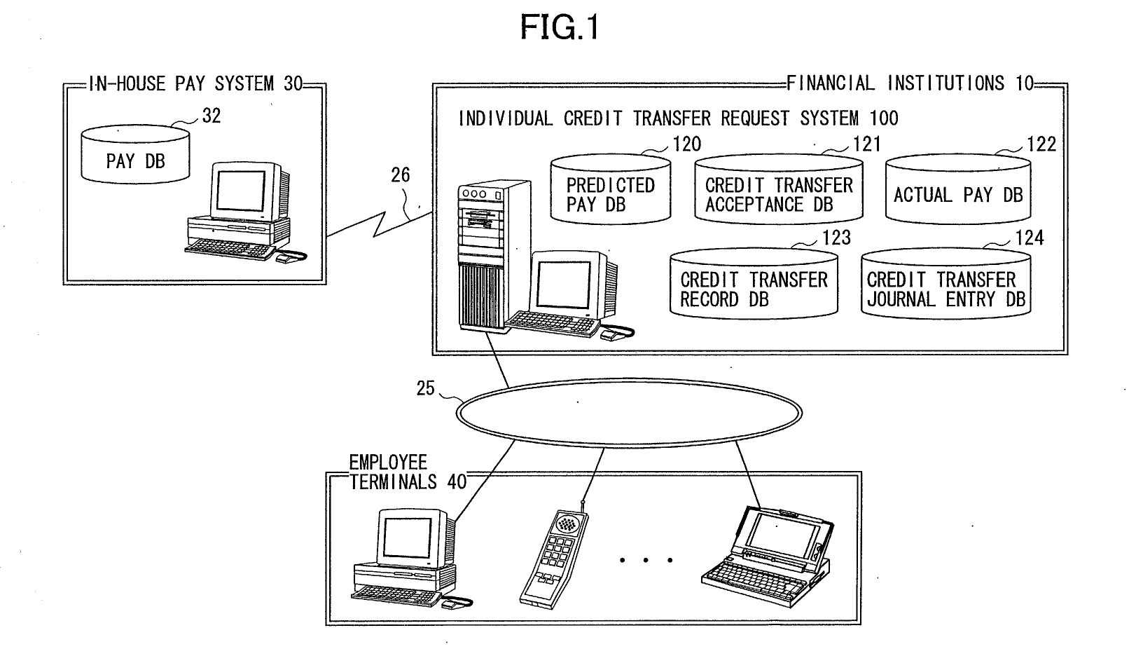

The preferred embodiments of the present invention will be described below by reference to drawings. An individual credit transfer request system 100 to which the credit transfer method is applied is, for example, a computer system connected to a network system shown in FIG. 1.

Employees access the individual credit transfer request system 100 located in a bank 10 through the Internet 25 using employee terminals 40. An in-house pay system 30 accesses the individual credit transfer request system 100 through a common carrier leased line 26.

An employee inputs amounts to be transferred to a plurality of bank accounts using an employee terminal 40. The information such as the amounts and the bank accounts is stored in a credit transfer acceptance database (DB) 121.

Pay data of each employee is transferred from a pay database (DB) 32 in the in-house pay system 30 to the bank 10, and stored in an actual pay database (DB) 122 managed by the individual credit transfer request system 100. On a payday, the individual credit transfer request system 100 transfers salaries and wages in accordance with the information stored in the credit transfer acceptance database 121.

As described above, the bank 10 can offer credit transfer services to the employees working for companies by managing both the pay data obtained from the companies and the credit transfer data input by the employees.

The companies are required only to manage the in-house pay system 30 as previously operated, and the employees working for the companies are required only to designate amounts to be transferred to a plurality of bank accounts, to the individual credit transfer request system 100 through the Internet 25.

Accordingly, the employees do not need to arrange credit transfers one by one in person on a payday, but just check the amounts transferred to the designated bank accounts.

Additionally, the employees can arrange the credit transfers through the Internet any time anywhere.

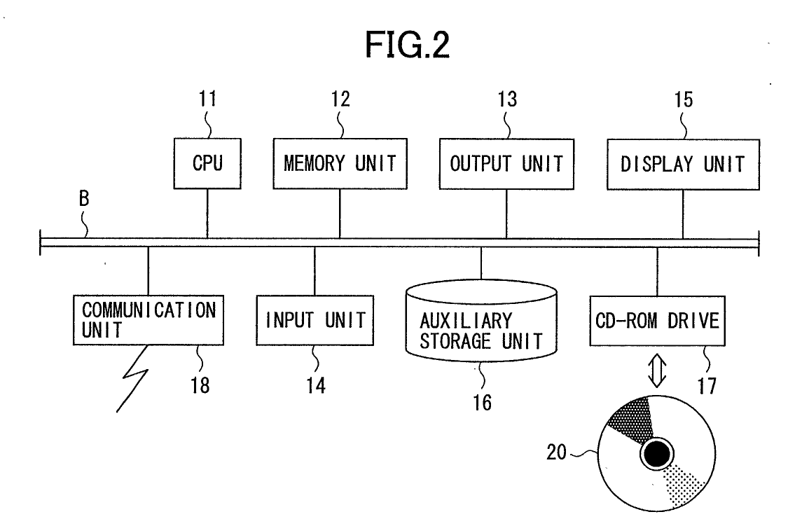

The hardware configuration of the individual credit transfer request system 100, for example, is shown in FIG. 2.

The individual credit transfer request system 100 includes a central processing unit (CPU) 11, a memory unit 12, an output unit 13, an input unit 14, a display unit 15, an auxiliary storage unit 16, a CD-ROM drive unit 17, and a communication unit 18. Each unit is connected to a bus B.

The CPU 11 controls the individual credit transfer request system 100 and processes all requests of credit transfer by executing the computer program stored in the memory unit 12. The memory unit 12 consisting of RAMs and ROMs stores the computer program executed by the CPU 11 and data being and having been processed by the CPU 11. A portion of the memory area of the memory unit 12 is used by the CPU 11 as a work area.

The output unit 13 includes a printer, for example, and outputs designated data. The input unit 14 includes, for example, a mouse and a keyboard with which an administrator inputs required information and manipulates data, which will be described later. The display unit 15 displays information necessary for the administrator under the CPU's control.

The auxiliary storage unit 16 consists of a rigid disk unit, for example, and stores various files, databases, and computer programs.

The computer program with connection to the processing of credit transfers stored in a CD-ROM 20, for example, is provided to the individual credit transfer request system 100. Once the CD-ROM 20 is set in the CD-ROM drive unit 17, the computer program connected with the processing of credit transfers is retrieved and installed in the auxiliary storage unit 16 through the bus B. The CPU 11 executes the computer program installed in the auxiliary storage unit 16. Besides the CD-ROM 20, any computer readable media can be the storage media in which the computer program connected with the processing of credit transfers is stored.

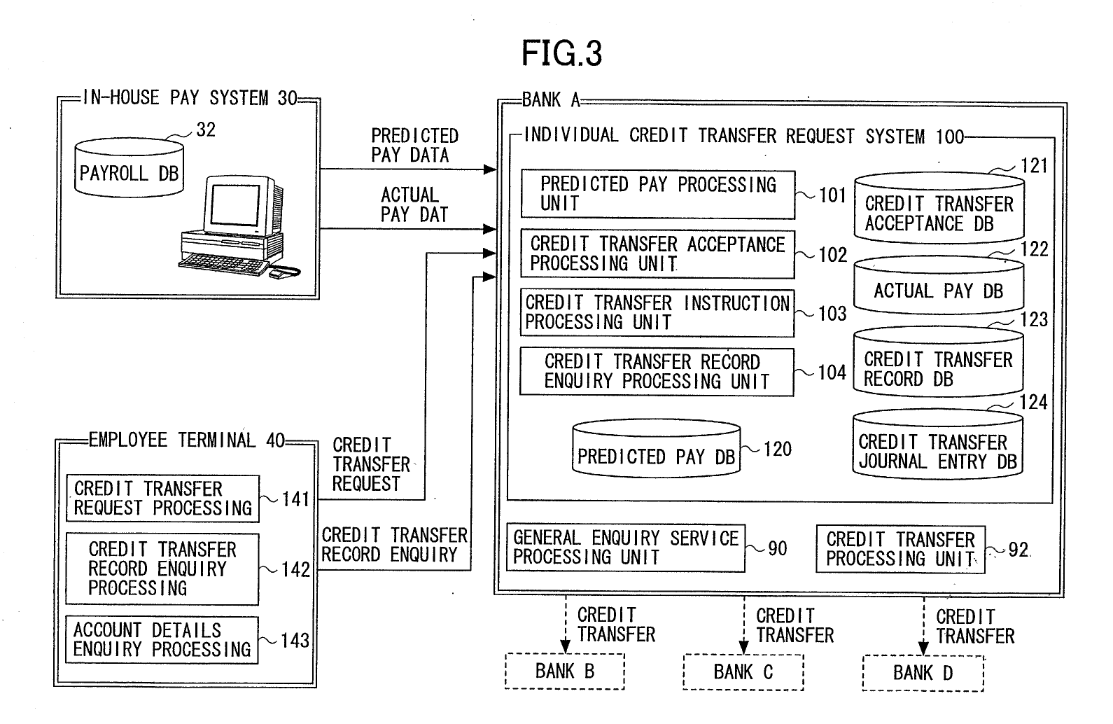

The function of the individual credit transfer request system 100 is described by reference to FIG. 3.

A bank A is the bank that processes credit transfers for the company.

As shown in FIG. 3, the bank A has a conventional general inquiry service processing unit 90 dealing with account details inquiries, balance inquiries, and deposit/credit inquiries, a conventional credit transfer processing unit 92, and the individual credit transfer request system 100, an embodiment of the present invention. The individual credit transfer request system 100 includes a predicted pay processing unit 101, a credit transfer acceptance processing unit 102, a credit transfer instruction processing unit 103, a credit transfer record inquiry processing unit 104, a predicted pay database (DB) 120, a credit transfer acceptance DB 121, an actual pay DB 122, a credit transfer record DB 123, and credit transfer journal entry DB 124. Each unit is controlled by the CPU 11 shown in FIG. 2. The databases 120 through 124 are stored in the auxiliary storage unit 16 shown in FIG. 2.

Each employee can perform credit transfer request processing 141, credit transfer record inquiry processing 142, and account detail inquiry processing 143 of the debits/credits in a designated account. These processings are accomplished by the individual credit transfer request system 100 through a browser installed in an employee terminal 40.

The predicted pay processing unit 101 regularly receives pay prediction data sent from the in-house pay system 30 and manages the pay prediction data for each employee by the predicted pay DB 120. If no pay prediction data is available from the in-house pay system 30, an average salary of a predetermined period or a salary of the previous month, for example, is used as the pay prediction data.

The credit transfer acceptance processing unit 102 manages the credit transfer requests received from the employee terminal 40 using the credit transfer acceptance DB 121.

If pay data sent from the in-house pay system 30 is a credit transfer instruction of salaries and wages, the credit transfer instruction processing unit 103 transfers designated amounts to each account of banks B, C, and D before transferring the remaining amount to the employee's account at the bank A by reference to information stored in the actual pay DB 122 and the credit transfer acceptance DB 121.

The credit transfer record inquiry processing unit 104 provides information connected to credit transfer records in response to credit transfer record inquiries sent from the employee terminal 40.

An employee sends, from the employee terminal 40, a credit transfer request to the bank A by performing credit transfer request processing 141. By activating credit transfer record inquiry processing 142 on the employee terminal 40, the employee sends a credit transfer record inquiry to the bank A, and checks credit transfer records including credit transfers to other bank accounts. The employee can check balances of the other bank accounts that the employee manages, by performing account details inquiry processing 143 of the designated account.

The employee terminal 40 can be any network device such as a personal computer or mobile terminal having a browser function.

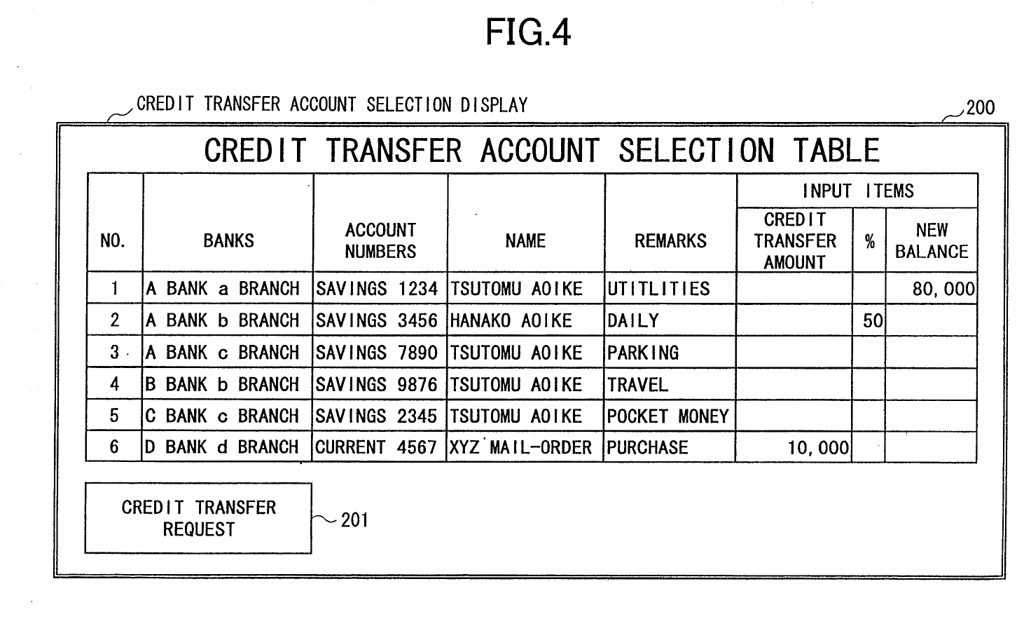

A screen image example is described by reference to FIG. 4.

A credit transfer account selection display 200 shown in FIG. 4 is a table of credit transfer accounts to which the employee “Tsutomu Aoike” transfers his pay, for example. The credit transfer account selection table has columns indicating numerals, banks and branches, account numbers, names, remarks, and input items consisting of credit transfer amounts, credit transfer percentages, and balances after a credit transfer.

In the credit transfer account selection table, the user “Tsutomu Aoike” can input data in remarks column and input item columns. If he wants to know more detailed information of the credit transfer accounts, the user is required to click one or more rows that he wants to select, then click a “credit transfer request” button 201.

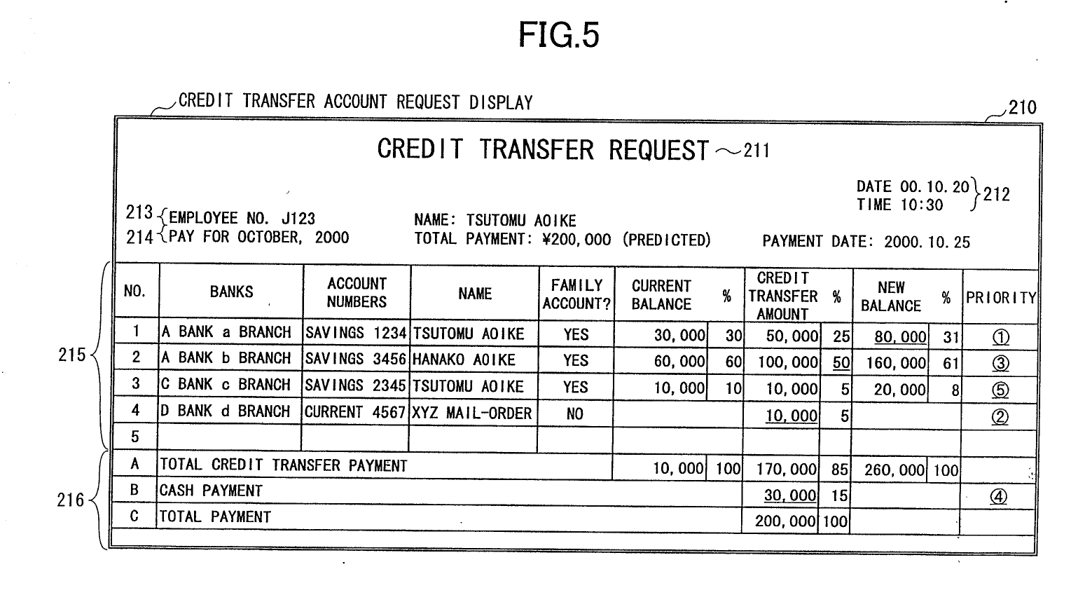

In response to the click on the “credit transfer request” button 201, a credit transfer request display 210 is shown on the screen of the employee terminal 40 shown in FIG. 5, for example.

The credit transfer request display 210 includes a title 211, the date and time 212, employee information 213, predicted pay 214, credit transfer accounts list 215, and pay amount information 216.

In the credit transfer request display 210 shown in FIG. 5, the date and time 212 is 10:30, Oct. 20, 2000, and the employee information 213 is “Tsutomu Aoike” having an employee No. J123. The credit transfer accounts list 215 and pay amount information 216 are shown in the credit transfer request display 210 based on the predicted pay information 214 indicating a total pay amount of October, 2000, ¥200,000 (predicted).

The pay prediction information 214 is the information managed by the predicted pay processing unit 101 and stored in the predicted pay DB 120.

The credit transfer accounts list 215 includes the credit transfer accounts that are selected by the user by reference to the credit transfer account selection display 200 shown in FIG. 4, and indicates credit transfer accounts, account numbers, distinctions of family account, current balances and corresponding percentages, new balances after credit transfer and corresponding percentages, and the priority of each credit transfer.

The pay amount information 216 includes pay amount information A indicating the amount to be credit transferred, pay amount information B indicating the amount to be paid by cash, and pay amount information C indicating the total amount of the pay. The pay amount information A indicates the total amount of current balances included in the credit transfer accounts list 215 and corresponding percentage to the total amount (usually 100%), the total amount of credit transfer amounts included in the credit transfer accounts list 215 and corresponding percentage to the total amount, and the total amount of new balances after credit transfers included in the credit transfer accounts list 215 and corresponding percentage to the total amount (usually 100%). The pay amount information B indicates the cash amount, corresponding percentage, and a priority. The pay amount information C indicates the total amount of the pay amount information A and the pay amount information B, and corresponding percentage to the total amount (usually 100%).

In the credit transfer request display 210 shown in FIG. 5, four bank accounts selected by the user “Tsutomu Aoike” are listed in the credit transfer accounts list 215.

The user can input amounts by nominal amount or percentage of the total amount. The underlined figures are input by the user.

For example, a user “Tsutomu Aoike” allocates ¥80,000 to the bank account indicated by No. 1 by which utilities bills and telephone bills are settled and 50% of the total amount as household expenses to a wife's bank account indicated by No. 2. He settles a mail-order bill by credit transferring ¥10,000 to a bank account indicated by No. 4 and receives ¥30,000 as pocket money in cash. The remainder is deposited.

The credit transfer request display 210 shows that the destination bank account, “Savings No. 1234” of “A bank, a branch” is owned by “Tsutomu Aoike”, and it is classified as one of family accounts. The table further shows that the balance of the bank account is ¥30,000, 30% of the total balance. Since the user has inputted ¥80,000 as the new balance after credit transfer to the bank account, the system automatically calculates the credit transfer amount, ¥50,000. A user can designate a desired balance after credit transfer is performed.

The credit transfer request display 210 further shows that the No. 2 bank account, “Savings No. 3456” of “B bank b branch” is owned by “Hanako Aoike”, is one of family accounts, and has a balance ¥60,000, 60% of the total balance before the credit transfer is performed. Since the user has input 50% of the total amount of pay, the credit transfer amount, ¥100,000, and the balance after credit transfer, ¥160,000, are automatically calculated. As described above, a user can designate the credit transfer amount by a percentage of the total predicted pay.

Furthermore, because the No. 4 bank account, “Current No. 4567” of “D bank d branch” is owned by “XYZ Mail-Order Company”, the table shows the bank account is not a family account, and no balances before and after the credit transfer are shown. The user is required to input the credit transfer amount “¥10,000”.

The user can input the amount “¥30,000” that the user desires to be paid in cash in the row “cash payment” indicated by B.

The user is required to input priorities of credit transfers. For example, the “No. 1” bank account “A bank a branch” has a priority “\mathring{1}”; the “No. 4” bank account “D bank d branch” has a priority “\mathring{2}”; the “No. 2” bank account “B bank b branch” has a priority “\mathring{3}”; the cash payment has a priority “\mathring{4}”; and the “No. 3” bank account “C bank c branch” has a priority “\mathring{5}”.

By the way, the “No. 3” bank account, “Savings No. 2345” of “C bank c branch”, is owned by “Tsutomu Aoike” as a family account, and has a balance “¥10,000”, 10% of the total current balance. Because the user has assigned a priority “\mathring{5}” to this bank account, a credit transfer amount “¥10,000” is automatically calculated. As described above, the user can deposit the remaining amount by designating only the priority without a specific amount. If the “No. 3” bank account is designated for saving, this manner of designation is effective.

Once all the amounts are input or calculated, percentages of each credit transfer amount of the total credit transfer amount and percentages of each balance after credit transfer of the total balance are calculated. For example, in the case of the “No. 1” bank account, the credit transfer amount, ¥50,000, is 25 percent of the total amount ¥200,000, and its balance after the credit transfer, ¥80,000, is 31 percent of the new total balance ¥260,000. In the case of “No. 2” bank account, because 50% of the total credit transfer amount is transferred, the new balance after the credit transfer is “¥160,000” of which share is 61%. In the case of “No. 3” bank account, ¥10,000, 5% of the total credit transfer amount, is transferred, and the new balance after credit transfer is “¥20,000”, 8% of the total new balance. Furthermore, because the user desires ¥30,000 in cash, the total credit transfer amount is “¥170,000”, 85% of the total amount, and the total new balance after the credit transfer becomes “¥260,000” (100%). The percentage of the cash payment is 15% as shown in the row of cash payment.

A user can add a new bank account by inputting required information in the fifth row that is left blank.

Once the user finishes inputting necessary information in the credit transfer request display 210, input information is sent as a credit transfer request to the individual credit transfer request system 100. The credit transfer acceptance processing unit 102 of the individual credit transfer request system 100 shown in FIG. 3 receives the credit transfer request from the employee terminal 40 and manages the credit transfer request with the credit transfer acceptance DB 121. Credit transfer request processing 141, initiated by the employee terminal, finishes.

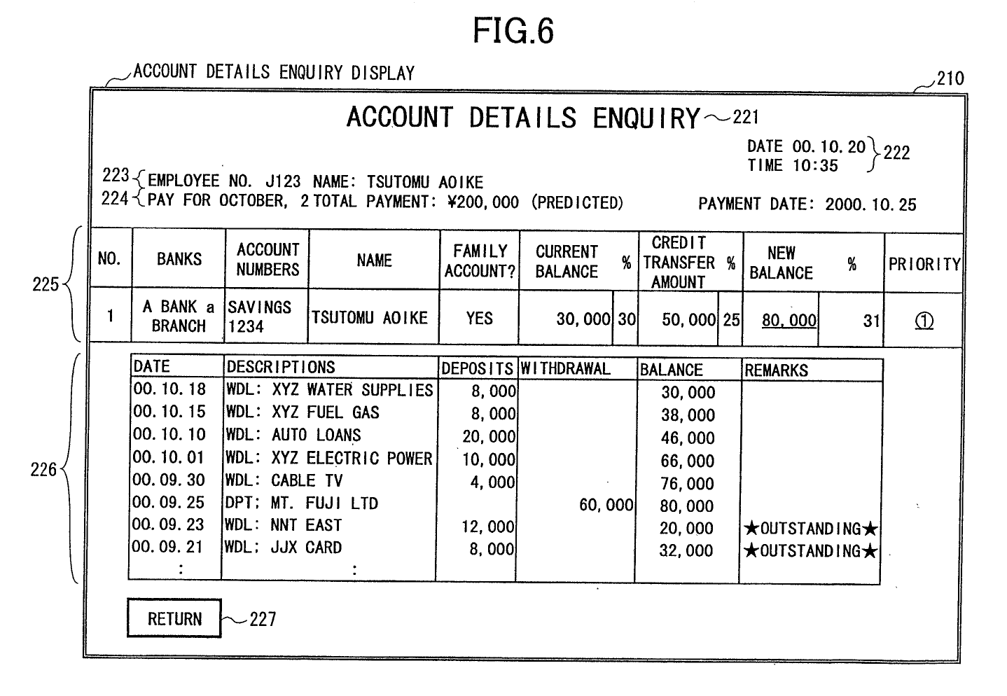

On the other hand, the user can refer to the detailed description of each bank account as shown in FIG. 6 (No. 1 is clicked in this case) by clicking the numeral in the first column of each row. That is, account details inquiry processing 143 of the employee terminal 40 shown in FIG. 3 is activated and sends an account details inquiry about the designated bank account to the general inquiry service processing unit 90 of the bank A. The general inquiry service processing unit 90 of the bank A provides the employee terminal 40 with account details in response to the account details inquiry. The account details that are sent from the bank A are displayed in the account details inquiry display as shown in FIG. 6.

FIG. 6 shows an example of an account details inquiry display 220.

The account details inquiry display includes a display title 221, the current date and time 222, employee information 223, predicted pay information 224, designated bank account information 225, account detailed information 226, and a button 227 that is an exit back to the previous credit transfer request display 210.

The account details inquiry display 220 shown in FIG. 6 indicates the display title, the current data and time 222 “date 00.10.20, time 10:35”, and the employee information 223 “Employee No.: J123, Name: Tsutomu Aoike”. The account details inquiry display 220 further indicates the predicted pay information 224 “For October, 2000 Predicted pay: ¥200,000 Payment date: Oct. 25, 2000”, the designated bank account information 225, and the account detailed information 226.

The predicted pay information 224 is displayed based on the information managed by the predicted pay processing unit 101 with the predicted pay DB 120.

The account details 226 indicate the destination account selected by the user in the credit transfer request display 210 shown in FIG. 5. The account details 226 indicate the “savings account No. 1234” of “A bank a branch” in this case. The account details 226 include the date of deposits and withdrawals, descriptions, withdrawal amounts, deposit amounts, balances, and remarks. The remarks “OUTSTANDING” in the rows corresponding to “00.09.23” and “00.09.21” indicate that the bills of this month are not yet all settled.

The user can predict the balance of the bank account by checking the account details 226.

The user can return to the credit transfer request display 210 by clicking the button 227.

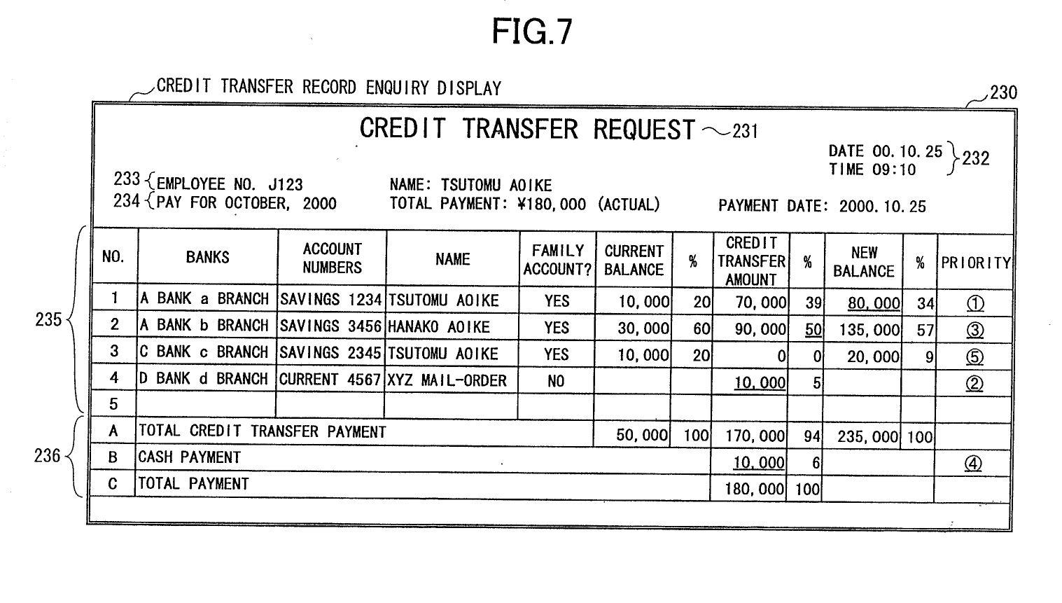

By activating credit transfer record inquiry processing 142 of the employee terminal 40, the user can check the credit transfer record indicated in a credit transfer record inquiry display 230 shown in FIG. 7.

FIG. 7 shows an example of the credit transfer record inquiry display 230.

The credit transfer record inquiry display 230 shown in FIG. 7 includes a display title 231, the current date and time 232, employee information 233, actual pay information 234, a list of destination bank accounts 235, and actual pay information 236. In FIG. 7, underlined figures are information that is input by the user referring to the credit transfer request display shown in FIG. 5.

The credit transfer record inquiry display 230 indicates the current date and time “date: 00. 10.25 time: 09:10”, the employee information 233 “employee No.: J123 Name: Tsutomu Aoike”, and the display title 231. The credit transfer record inquiry display 230 further indicates the actual pay information 234 “Pay for October, 2000 Actual amount: ¥180,000 Payment date: 10.25, 2000”, the destination bank accounts list 235 and the actual pay information 236.

The destination bank accounts list 235 lists the bank accounts selected by the user referring to the credit transfer account selection display 200. The destination bank accounts list 235 further indicates a numeral, a destination bank and branch, an account No., an owner's name, a classification of family account, a balance before the credit transfer and its percentage, a credit transfer amount and its percentage, a balance after the credit transfer and its percentage, and a priority. The credit transfer amount and its percentage, and the balance after the credit transfer and its percentage are calculated based on the actual pay.

For example, the bank account No. 1 indicates the balance before the credit transfer, “¥110,000” and its percentage, “20%”, the credit transfer amount, “¥70,000” and its percentage, “39%”, and the balance after the credit transfer, “¥80,000” and its percentage “34%”. The bank account No. 2 indicates the balance before the credit transfer “¥30,000” and its percentage “60%”, the credit transfer amount “¥90,000” and its percentage “50%”, and the balance after the credit transfer “¥135,000” and its percentage “57%”. The bank account No. 3 indicates the balance before the credit transfer “¥10,000” and its percentage “20%”, the credit transfer amount “¥0” and its percentage “0%”, and the balance after the credit transfer “¥20,000” and its percentage “9%”. The bank account No. 4 indicates the credit transfer amount “¥10,000” and its percentage “5%”.

The actual pay information 236 includes, as the predicted pay amount information 216 does, a credit transfer payment A indicating the amount paid by credit transfer, a cash payment B indicating the amount paid in cash, and a total actual pay amount C. Since the items A, B, and C of the actual pay information 236 are identical to those of the predicted pay amount information 216 shown in FIG. 5, their explanation is omitted.

In this case, the sum of the balances before the credit transfer is “¥50,000” and its percentage (to the total) “100%”, the total credit transfer payment A “¥170,000” and its percentage “94%”, and the sum of the balances after the credit transfer is “¥235,000” and its percentage “100%”. The actual pay information B, that is, the cash payment indicates “¥10,000” and its percentage is “6%”. The total predicted pay amount indicated in the actual pay information C is “¥180,000” and its percentage (to the total) is “100%”.

Accordingly, because the actual pay “¥180,000” is less than the predicted pay “¥200,000” by ¥20,000, the amount allocated to the cash payment having the 3^{rd} priority becomes “¥10,000” instead of “¥30,000”, and the amount allocated to the bank account No. 3 having the lowest priority becomes “¥0” instead of “¥10,000”.

The individual credit transfer request system 100 allocates money to the bank accounts having higher priority first, and reduces the amounts to be allocated to the bank accounts having lower priority.

The operation of the individual credit transfer request system 100, the operation that is activated by each step of the user's operation of the employee terminal 40, is explained below.

The individual credit transfer request system 100 of the bank A takes data indicating employee's predicted pay before a payment day, and manage the data with the predicted pay DB 120. Otherwise, the actual pay of the previous month is regarded as the predicted pay.

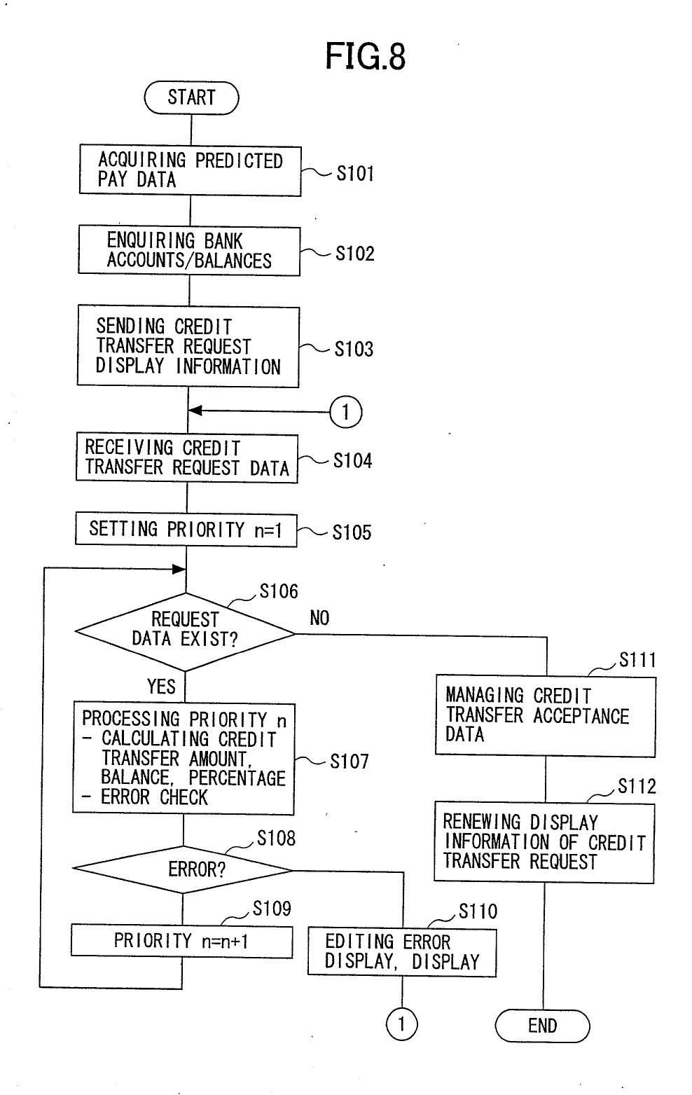

FIG. 8 is a flow diagram showing credit transfer acceptance processing 141.

As soon as credit transfer request processing 141 is activated, it requests the individual credit transfer request system 100 to send the information connected (employee information) to the credit transfer request display 210. In response to the receipt of the request, the individual credit transfer request system 100 has the predicted pay processing unit 101 fetch the predicted pay data stored in the predicted pay DB 120 (Step S101). The general inquiry service processing unit 90 acquires the current balances of the destination bank accounts designated by the request (S102), and sends the current balances as a part of the credit transfer request display information to the employee terminal 40. The employee terminal 40 displays the credit transfer request display information using the format of the credit transfer request display 210 shown in FIG. 5.

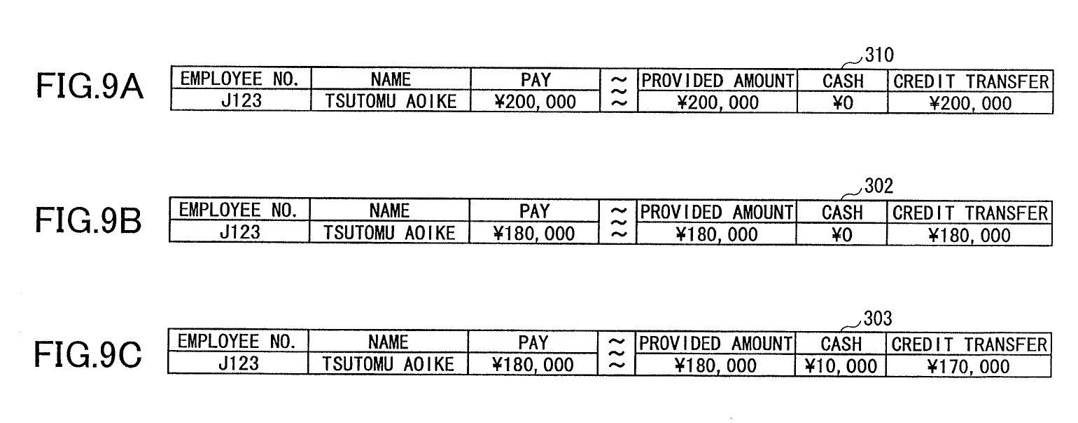

The individual credit transfer request system 100 of the bank A acquires predicted pay data 301, for example, as shown in FIG. 9A. The predicted pay data 301 includes an employee No., the employee name, a predicted pay as of the date of the request, an actual pay to be actually paid, a cash amount indicating payment in cash, and a credit transfer amount indicating payment by credit transfers. For example, the predicted pay data 301 shows the employee No. “J123”, the employee name “Tsutomu Aoike”, the predicted pay “¥200,000”, the actual pay “¥200,000”, the cash amount “¥0”, and the credit transfer amount “¥200,000”. This predicted pay data 301 is managed by the predicted pay DB 120 of the predicted pay processing unit 101, and fetched in the step S103.

The individual credit transfer request system 100 receives credit transfer request data inputted by a user from the credit transfer request display 210 shown in FIG. 5 (Step S104). The individual credit transfer request system 100 further activates the credit transfer acceptance processing unit 102 and sets an index number indicating the priority “priority n” at 1 (S105).

The credit transfer acceptance processing unit 102 determines whether credit transfer request data having the “priority n”=1 exists (S106). If credit transfer request data having the “priority n”=1 exists, the credit transfer request data having the “priority n”=1 is processed (S107). That is, based on the request, the calculation of a credit transfer amount and its percentage to the total credit transfer amount, and the calculation of a new balance after the credit transfer and its percentage to the total new balance are performed as well as error checking.

The credit transfer acceptance processing unit 102 determines whether any error is caused (Step S108). If any error occurs, the credit transfer acceptance processing unit 102 creates an error message display, sends the error message to the employee terminal 40 (S110), and then returns to the step S104 waiting for the receipt of the next credit transfer request.

If no error is found, the “priority n” is increased by 1 (S109). The credit transfer acceptance processing unit 102 returns to the step S106. In the case of the credit transfer request display 210 shown in FIG. 5, the steps S107 and S108 are repeated until the “priority n” is less than 5. When the “priority n” becomes 5, the credit transfer acceptance processing unit 102 proceeds to the step S111 because the decision S106 is negative.

The credit transfer acceptance processing unit 102 manages the credit transfer request data that has processed through the steps S107 and S108 as credit transfer acceptance data with the credit transfer acceptance DB 121 (S111). The credit transfer acceptance processing unit 102 renews the credit transfer request display 210 shown on the employee terminal 40 by reflecting the credit transfer acceptance data. Then, the credit transfer acceptance processing is over.

If the user requests a change in the credit transfer request data using the employee terminal 40, the individual credit transfer request system 100 starts processing the request of the change at the step S104 in which the request of the change is received. New credit transfer acceptance data after the change replaces the old credit transfer acceptance data before the change stored in the credit transfer acceptance DB 121 in the step S111.

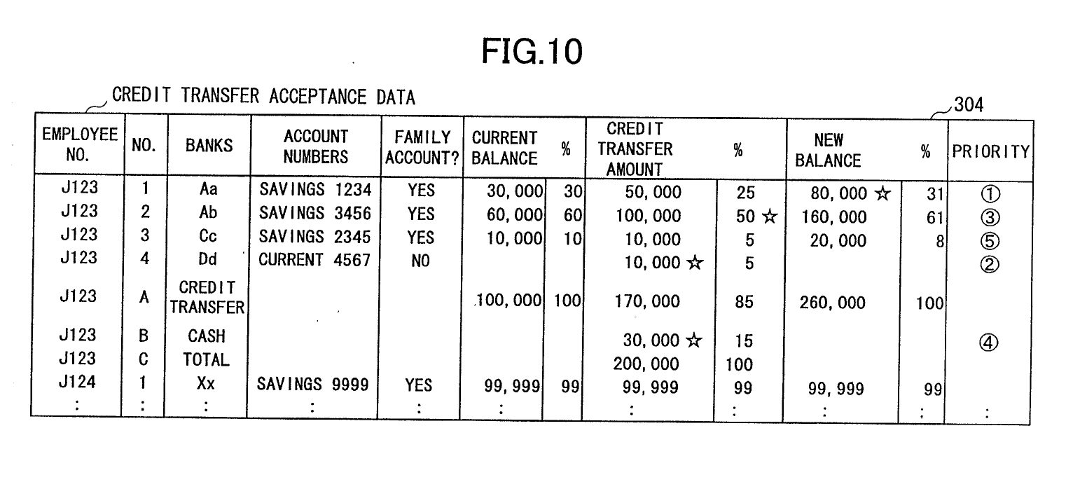

The credit transfer acceptance data created using the credit transfer request display 210 as described above is stored in the credit transfer acceptance DB 121 as credit transfer acceptance data shown in FIG. 10, for example.

FIG. 10 is a schematic drawing showing an example of credit transfer acceptance data.

The credit transfer acceptance data 304 shown in FIG. 10 includes an employee number, a row number (selection number) indicated in the credit transfer accounts list 215 and the pay amount information 216 of the credit transfer request display 210, a bank name being the destination of a credit transfer, an account number, a remark indicating whether the bank account is a family account, a current balance and its percentage to the total current balance, a credit transfer amount and its percentage to the total credit transfer amount, a new balance after the credit transfer and its percentage to the total new balance, and a priority of credit transfer. The ☆ mark shown in FIG. 10 indicates information input by the user.

Next, the operation of the credit transfer instruction processing unit 103 of the individual credit transfer request system 100 will be described below.

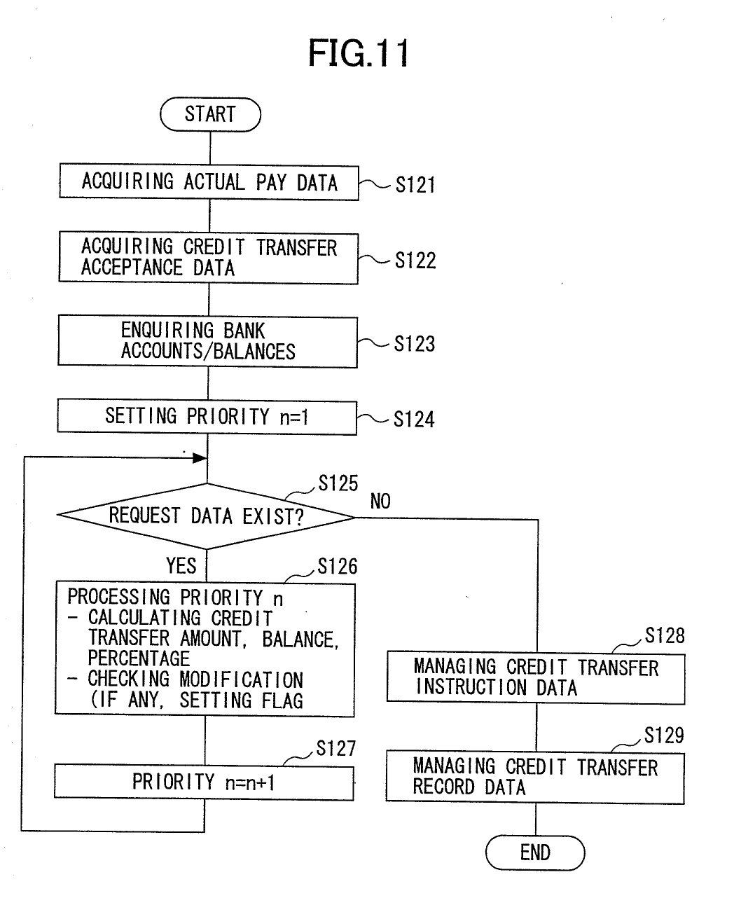

FIG. 11 is a flow diagram of the operation of the credit transfer instruction unit 103.

In response to the reception of actual pay data 302 shown in FIG. 9B, for example from the in-house pay system 30 (Step S121), the individual credit transfer request system 100 activates the credit transfer instruction processing unit 103 to manage the actual pay data 302 with the actual pay DB 122, and retrieves the credit transfer acceptance data 304 from the credit transfer acceptance DB 121 (step S122). The actual pay data 302 shown in FIG. 9B includes an employee number, an employee name, a predicted pay as of the date, the actual pay, a cash amount, and a credit transfer amount. For example, the actual pay data 302 indicates that an amount of “¥180,000” is paid to “Mr. Tsutomu Aoike” whose employee number is “J123”, “¥0” in cash and “¥180,000” by credit transfer based on the actual pay “¥180,000”.

The credit transfer instruction processing unit 103, in response to the receipt of the credit transfer acceptance data 304, activates the general inquiry service processing unit 90 to inquire about the account details and balance of each bank account designated by the credit transfer acceptance data 304, and acquires the current balance before the credit transfer (Step S123).

The credit transfer instruction processing unit 103 sets the “priority n” indicating the order of priority at 1 (S124).

The credit transfer instruction processing unit 103 determines whether any credit transfer request data having the “priority n”=1 exists (S125). If a credit transfer request data having the “priority n”=1 exists, the credit transfer request data having the “priority n”=1 is processed (S126). That is, each credit transfer amount and its percentage to the total credit transfer amount, and each balance after the credit transfer and its percentage to the total balance after the credit transfer are calculated based on the actual pay data 302 and the credit transfer acceptance data 304. If there is any change in the credit transfer request data, a change flag is set.

The credit transfer instruction processing unit 103 increases the “priority n” by 1 (Step S127), and returns to the step S125. In the case of the credit transfer request display 210 shown in FIG. 5, the steps S126 and S127 are repeated unless the “priority n” becomes 5. If the “priority n” becomes 5, the credit transfer instruction processing unit 103 proceeds to the step S128 since the decision S125 becomes negative.

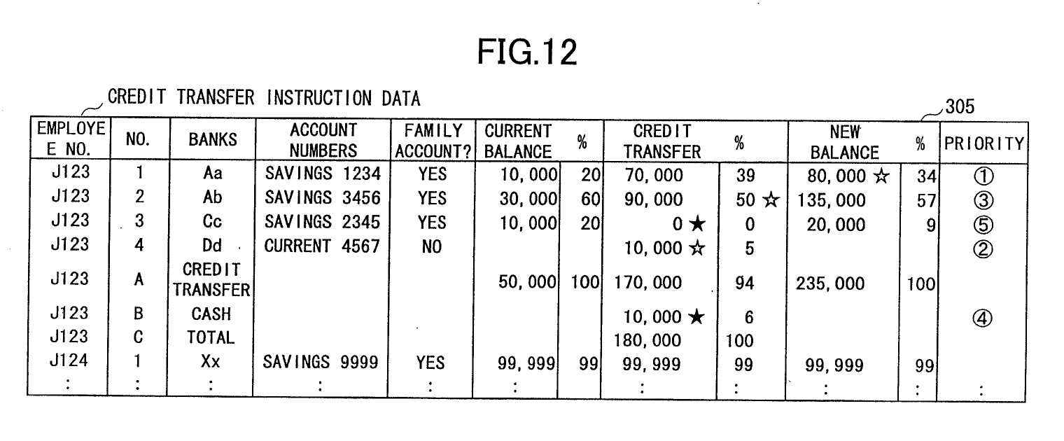

In the step S128, the credit transfer instruction processing unit 103 manages the information obtained by performing the steps S125 through S127 as credit transfer instruction data 305 as shown in FIG. 12 using the credit transfer record DB 123 (S128). The credit transfer instruction data 305 shown in FIG. 12 has the same data structure as the credit transfer acceptance data 304, including employee numbers, the row numbers (selection numbers) indicated in the credit transfer accounts list 215 or the pay amount information 216 in the credit transfer request display 210, bank names to which the credit transfers are made, account numbers, remarks indicating whether the bank account is a family account, current balances before credit transfers and its percentages, credit transfer amounts and their percentages to the total credit transfer amount, new balances after credit transfers and their percentages to the total credit transfer amount, and their priorities. The ★ marks in FIG. 12 indicate that the figures are different from those designated by the user. Since the actual pay is less than the predicted pay in this case, the figures marked by ★ are less than those designated by the user. The figures followed by a ☆ mark are the figures input by the user.

The credit transfer record DB 123 stores credit transfer record data 303 shown in FIG. 9C that is the summary of the credit transfer instruction data 305. The credit transfer record data 303 includes an employee number, an employee name, an actual pay amount, an actual amount provided, a cash amount provided, and a credit transfer amount provided. The credit transfer record data 303 shown in FIG. 9C, for example, indicates that “Mr. Tsutomu Aoike” whose employee number is “J123” earns an actual pay amount “¥180,000” and is provided with an actual amount “¥180,000”, “¥10,000” in cash and “¥170,000” by credit transfer.

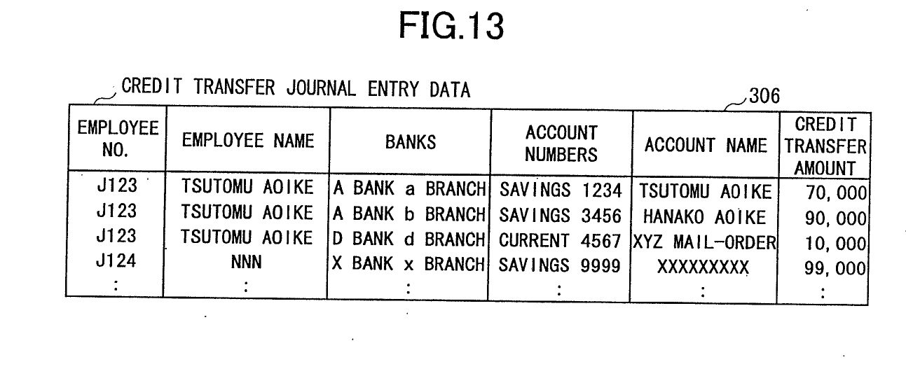

The credit transfer instruction processing performed by the credit transfer instruction processing unit 103 creates journal entries to transfer the designated amounts to the designated bank accounts B, C, and D based on the information stored in the credit transfer record DB 123. The credit transfer processing unit 92 performs the credit transfers based on the journal entries. An example of credit transfer journal entry data is shown in FIG. 13.

FIG. 13 is a schematic drawing showing an example of the credit transfer journal entry data.

The credit transfer journal entry data 306 includes columns indicating the employee number, the employee name, the bank name, the bank account, the account name, and the amount of the credit transfer, etc.

The credit transfer journal entry data 306 is created based on the credit transfer instruction data 305 shown in FIG. 12. For example, the employee number, the bank name, the account number, and the credit transfer amount of the credit transfer journal entry data 306 are corresponding to the employee number, the bank name, the account number, and the credit transfer amount of the credit transfer instruction data 305, respectively. The employee name of the credit transfer journal entry data 306 is obtained from an employee table that relates the employee number and the employee name. The account name is obtained from the customer list of each bank.

Because the individual credit transfer request system 100 performs the credit transfers designated by the user automatically, the user does not need to visit the banks to arrange each credit transfer one by one after the user receives his/her pay. The individual credit transfer request system 100 helps the user to save time substantially.

A description of credit transfer record inquiry processing performed by the credit transfer record inquiry processing unit 104 will be given next.

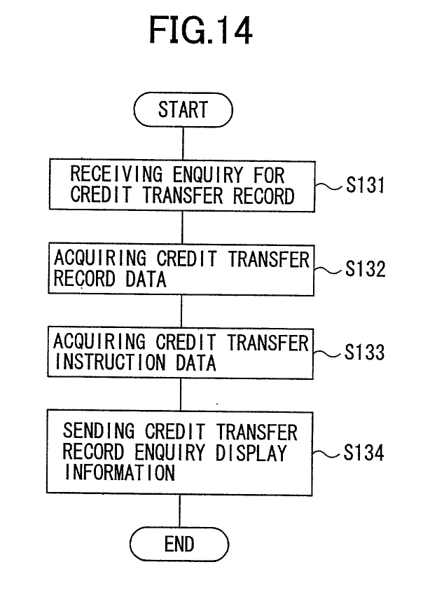

FIG. 14 is a flow diagram of the operation of credit transfer record inquiry processing.

The individual credit transfer request system 100, in response to the receipt of a credit transfer record inquiry from the employee terminal 40 (Step S131), activates the credit transfer record inquiry processing unit 104.

The credit transfer record inquiry processing unit 104 acquires the credit transfer record 303 from the credit transfer record DB 123 (S132) and the credit transfer instruction data 305 from the credit transfer record DB 123 (S133).

The credit transfer record inquiry processing unit 104 creates, based on the credit transfer record 303 and the credit transfer instruction data 305, the credit transfer record inquiry display 230 as shown in FIG. 7 and sends the credit transfer record inquiry display 230 to the employee terminal 40.

In the description above, the individual credit transfer request system 100 is assumed to be a part of the financial system of the bank A, but the individual credit transfer request system 100 can be a part of the in-house pay system 30. In this case, the actual pay data 302 and the credit transfer journal entry data 306 are transferred to the bank A.

According to the embodiment described above, an employee does not need to visit his/her bank in person on the payment day to check whether a sufficient balance remains in an account and arrange credit transfers to other accounts. Instead, the employee sits in front of the employee terminal and allocates the total amount to each bank account.

According to the embodiment above, the employee designates both credit transfer amounts and their priorities, and the individual credit transfer request system automatically allocates money to designated accounts in order of the priorities designated by the employee and transfers the money. Accordingly, the employee can reduce time required to arrange the credit transfers.

If a bank implements the individual credit transfer request system, the bank can add more value to its financial services provided to its customers without asking for a change in customers' in-house pay systems.

Furthermore, besides monthly salary, any money provided to the employees such as bonuses and travel expenses are also transferred by the individual credit transfer request system.

The preferred embodiments of the present invention are described above. The present invention is not limited to these embodiments, but various variations and modifications may be made without departing from the scope of the present invention.

This patent application is based on Japanese priority patent application No. 2001-113160 filed on Apr. 11, 2001, the entire contents of which are hereby incorporated by reference.

What is claimed is:

1. A method of transferring a first pool of a predetermined amount of money to a plurality of bank accounts through a computer network, comprising the steps of:
receiving information indicating a priority order of the bank accounts and indicating money amounts that are to be transferred to the respective bank accounts;
transferring the money amounts from said first pool to the respective bank accounts in said priority order of the bank accounts as long as sufficient money to transfer remains in said first pool; and
transferring all money remaining in said first pool to a bank account that is next to receive money transfer in said priority order of the bank accounts if all the remaining money in said first pool is not sufficient for the indicated money amount to be transferred to the bank account.

2. The method as claimed in claim 1, wherein said information indicates balances of the respective bank accounts, instead of money amounts that are to be transferred to the respective bank accounts, that remain after said predetermined amount of money has been transferred.

3. The method as claimed in claim 1, wherein said money amounts are indicated by percentages on said predetermined amount of money.

4. The method as claimed in claim 1, further comprising a step of generating journal entries corresponding to the transferring of the money amounts, wherein the transferring of the money amounts are performed by said journal entries.

5. The method as claimed in claim 1, wherein said predetermined amount of money is to be transferred to a predetermined one of said bank accounts if said information fails to indicate said priority order of the bank accounts and money amounts that are to be transferred to the respective bank accounts.

6. The method as claimed in claim 1, further comprising the step of receiving information indicating a predicted amount of money to be transferred to the bank accounts, wherein a user can simulate the transferring of the predicted amount of money to the respective bank accounts.

7. The method as claimed in claim 1, further comprising:
a step of inquiring banks having said bank accounts for first detailed information indicating debits, credits, and a balance of the respective bank accounts; and
a step of sending said first detailed information to a user terminal.

8. The method as claimed in claim 1, further comprising a step of sending, to a user terminal through a computer network, second detailed information indicating debits, credits, and a balance of the respective bank accounts after the transferring of the money amounts.

9. A method for a user terminal of requesting to transfer a pool of a predetermined amount of money to a plurality of bank accounts through a computer network, comprising a step of sending information indicating a priority order of the bank accounts and indicating money amounts that are to be transferred to the respective bank accounts.

10. A computer system that transfers a pool of a predetermined amount of money to a plurality of bank accounts, comprising:
a communication unit that connects said computer system to said computer network;
an auxiliary storage device that stores data; and
a central processing unit that receives information indicating a priority order of the bank accounts and indicating money amounts that are to be transferred to the respective bank accounts, transfers the money amounts from said pool to the respective bank accounts in said priority order of the bank accounts as long as sufficient money to transfer remains in said pool, and transfers all money remaining in said pool to a bank account that is next to receive money transfer in said priority order of the bank accounts if all the remaining money in said pool is not sufficient for the indicated money amount to be transferred to the bank account.

11. A computer readable recording medium storing a computer program that transfers a pool of a predetermined amount of money to a plurality of bank accounts through a computer network, wherein said program causes the computer to:
receive information indicating a priority order of the bank accounts and indicating money amounts that are to be transferred to the respective bank accounts;
transfer the money amounts from said pool to the respective bank accounts in said priority order of the bank accounts as long as sufficient money to transfer remains in said pool; and
transfer all money remaining in said pool to a bank account that is next to receive money transfer in said priority order of the bank accounts if all the remaining money in said pool is not sufficient for the indicated money amount to be transferred to the bank account.
